(19) United States
(12) Patent Application Publication
(10) Pub. No.: US 2024/0154125 A1
(43) Pub. Date: May 9, 2024

(54) POLYTETRAFLUOROETHYLENE ENABLED LITHIUM FLORIDE LAYER ON BATTERY ELECTRODE FOR IMPROVING CYCLABILITY

(71) Applicant: GM GLOBAL TECHNOLOGY OPERATIONS LLC, Detroit, MI (US)

(72) Inventors: Dewen KONG, Shanghai (CN); Haijing LIU, Shanghai (CN)

(21) Appl. No.: 18/128,607

(22) Filed: Mar. 30, 2023

(30) Foreign Application Priority Data
Nov. 9, 2022 (CN) 202211399764.3

(51) Int. Cl. H01M 4/62; H01M 4/525; H01M 4/58; H01M 10/0525; H01M 10/0568; H01M 10/0569

(52) U.S. Cl. CPC H01M 4/623; H01M 4/525; H01M 4/58; H01M 10/0525; H01M 10/0568; H01M 10/0569

(57) ABSTRACT

A battery includes: an anode electrode including a lithium metal; a cathode electrode; and a lithium fluoride (LiF) layer disposed on at least one of the anode electrode and the cathode electrode formed via a reaction between a polytetrafluoroethylene (PTFE) layer and the at least one of anode electrode and the cathode electrode during a formation process of the battery.

### CROSS-REFERENCE TO RELATED APPLICATIONS

This application claims the benefit of Chinese Patent Application No. 202211399764.3, filed on Nov. 9, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to batteries and more particularly to electrodes of lithium ion batteries.

Vehicles with an engine include a battery for starting the engine and supporting accessory loads. Electric vehicles (EVs) such as battery electric vehicles (BEVs), hybrid vehicles, and/or fuel cell vehicles include one or more electric machines and a battery system including one or more battery cells, modules and/or packs to provide propulsion power. A power control system is used to control power to/from the battery system during charging, propulsion and/or regeneration.

Lithium-ion batteries (LIBs) have high power density and are used in EV and non-EV applications. LIBs include anode electrodes, cathode electrodes and separators. The anode electrodes include active material arranged on opposite sides of a current collector. The cathode electrodes include cathode active material arranged on opposite sides of a current collector.

### SUMMARY

In a feature, a battery includes: an anode electrode including a lithium metal anode; a cathode electrode; and a lithium fluoride (LiF) layer disposed on at least one of the anode electrode and the cathode electrode formed via a reaction between a polytetrafluoroethylene (PTFE) layer and the at least one of anode electrode and the cathode electrode during a formation process of the battery.

In further features, a portion of the PTFE layer remains after the reaction.

In further features, the LiF layer is disposed between the PTFE layer and the at least one of the anode electrode and the cathode electrode.

In further features, the PTFE layer has a porosity between approximately 30 percent and approximately 90 percent.

In further features, the LiF layer is disposed on the anode electrode.

In further features, the anode electrode includes graphite, Si, SiOx, LiSiOx and Graphite+Si containing anodes.

In further features, the cathode electrode includes lithium iron phosphate (LFP).

In further features, (a) Rock salt layered oxides, LiNixMnyCo1-x-yO2, LiNixMn1-xO2, Li1+xMO2 e.g. LiCoO2, LiNiO2, Li MnO2, LiNi0.5Mn0.5O2, NMC111, NMC523, NMC622, NMC721, NMC811, NCA etc. (b) Spinel cathode, e.g. LiMn2O4, LiNi0.5Mn1.5O4 (c) Olivine compounds, e.g. LiV2(PO4)3 LiFePO4, LiCoPO4, LiMnPO4 etc (d) Tavorite compounds, e.g. LiVPO4F, (e) Borate compounds, e.g. LiFeBO3, LiCoBO3, LiMnBO3 (f) Silicate compounds, e.g. Li2FeSiO4, Li2MnSiO4, LiMnSiO4F (g) Organic compounds, e.g. Dilithium (2,5-dilithiooxy)terephthalate, polyimide (h) Other types, e.g. S,O2 (i) Coated and/or doped cathode materials mentioned in (a), (b) and (j) Combination components selected from a to d type

In further features, an electrolyte fills the battery.

In further features, the electrolyte includes a carbonate.

In further features, the electrolyte includes lithium salts, e.g., Lithium hexaflourophosphate (LiPF₆).

In further features, a separator is disposed between the anode electrode and the cathode electrode.

In further features: the lithium metal of the anode electrode is one of pure lithium and a lithium alloy;

In further features, a thickness of the PTFE layer is between approximately 1 micrometer and approximately 25 micrometers.

In further features, a thickness of one side of the at least one of the Li Metal anode electrode is between approximately 1 micrometer and approximately 50 micrometers.

In a feature, a method of manufacturing a battery includes: before performing a formation process of the battery, applying a polytetrafluoroethylene (PTFE) layer and to one of an anode electrode and a cathode electrode of the battery, the anode electrode including a lithium metal; disposing the anode electrode and the cathode electrode within the battery; filling the battery with an electrolyte; and performing the formation process of the battery, the PTFE layer reacting with the at least one of the anode electrode and the cathode electrode and forming a lithium fluoride (LiF) layer on the at least one of the anode electrode and the cathode electrode.

In further features, the applying the PTFE layer includes applying the PTFE layer to one of the anode electrode and the cathode electrode when a temperature of the at least one of the anode electrode and the cathode electrode is greater than a predetermined temperature.

In further features, the applying the PTFE layer includes applying the PTFE layer by one of rolling, pressing, and spraying.

In further features, the electrolyte includes a carbonate.

In further features, the electrolyte includes a lithium salt.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of an example propulsion control system;

FIG. 3 is a functional block diagram of an example implementation of a battery;

FIG. 4A includes a cross-sectional view of an example implementation of an electrode before a formation process;

FIG. 4B includes a cross-sectional view of an example implementation of the electrode after the formation process;

FIG. 5A includes a cross-sectional view of an example implementation of an electrode before the formation process;

FIG. 5B includes a cross-sectional view of an example implementation of the electrode after the formation process; and

FIG. 6 is a flowchart depicting an example method of manufacturing a battery including disposing a lithium fluoride layer on an electrode of the battery.

In the drawings, reference numbers may be reused to identify similar and/or identical elements.

### DETAILED DESCRIPTION

Lithium metal electrodes in batteries are promising candidates for the anodes of high energy density batteries due to their lower reduction potential and high specific capacity. However, during charging and discharging of the battery (especially with carbonate including electrolytes), electrochemical plating and stripping of the Li metal electrodes may lead to growth of dendrites during cycling of the battery. The generation of dendritic Li during cycling can pierce the separator between anode and cathode causing short circuits and other events.

The present application involves applying a polytetrafluoroethylene (PTFE) layer to an electrode (e.g., the anode) prior to an electrolyte being input to a battery and formation of the battery being performed. The PTFE layer partially or completely changes into a lithium fluoride (LiF) layer within the battery during the formation process via a reaction with the Li metal of the electrode (that occurs during the charging and discharging of the formation process). The LiF layer suppresses lithium dendrite growth during later charging and discharging of the battery. If present, the PTFE layer reacts with Li Dendrite during cycling to minimize a risk of occurrence of short circuits and other events.

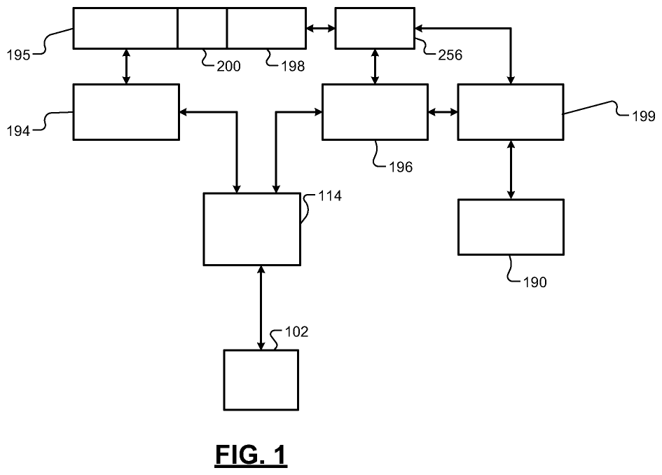

Referring now to FIG. 1, a functional block diagram of an example vehicle system is presented. While a vehicle system for a hybrid vehicle is shown and will be described, the present disclosure is also applicable to electric vehicles that do not include an internal combustion engine (including pure electric vehicles), fuel cell vehicles, autonomous vehicles, and other types of vehicles. Also, while the example of a vehicle is provided, the present application is also applicable to non-vehicle implementations.

An engine 102 may combust an air/fuel mixture to generate drive torque. An engine control module (ECM) 114 controls the engine 102. For example, the ECM 114 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 195. A transmission control module (TCM) 194 controls operation of the transmission 195. For example, the TCM 194 may control gear selection within the transmission 195 and one or more torque transfer devices (e.g., a torque converter, one or more clutches, etc.).

The vehicle system includes one or more electric motors, such as electric motor 198. An example implementation including more than one electric motor is described below. An electric motor can act as either a generator or as a motor at a given time. When acting as a generator, an electric motor converts mechanical energy into electrical energy. The electrical energy can be, for example, used to charge a battery 199. When acting as a motor, an electric motor generates torque that may be used, for example, for vehicle propulsion. While the example of one electric motor is provided, the vehicle may include more than one electric motor.

A motor control module 196 controls power flow from the battery 199 to the electric motor 198 and from the electric motor 198 to the battery 199. The motor control module 196 applies electrical power from the battery 199 to the electric motor 198 to cause the electric motor 198 to output positive torque, such as for vehicle propulsion. The battery 199 may include, for example, one or more batteries and/or battery packs. In various implementations, the battery 199 may be referred to as a battery pack or a rechargeable energy storage system. The battery 199 may be, for example, an 800 volt (V) DC battery or have another suitable voltage rating

The electric motor 198 may output torque, for example, to an input shaft of the transmission 195 or to an output shaft of the transmission 195, or to a wheel of the vehicle. A clutch 200 may be engaged to couple the electric motor 198 to the transmission 195 and disengaged to decouple the electric motor 198 from the transmission 195. One or more gearing devices may be implemented between an output of the clutch 200 and an input of the transmission 195 to provide a predetermined ratio between rotation of the electric motor 198 and rotation of the input of the transmission 195.

The motor control module 196 may also selectively convert mechanical energy of the vehicle into electrical energy. More specifically, the electric motor 198 generates and outputs power when the electric motor 198 is being driven by the transmission 195 and the motor control module 196 is not applying power to the electric motor 198 from the battery 199. The motor control module 196 may charge the battery 199 via the power output by the electric motor 198.

The vehicle includes a charge port 190. A power source, such as a charging station, another vehicle, or another suitable source of power may connect to and charge the battery 199 via the charge port 190. The battery 199 may also be used to power other devices (e.g., other vehicles) via the charge port 190.

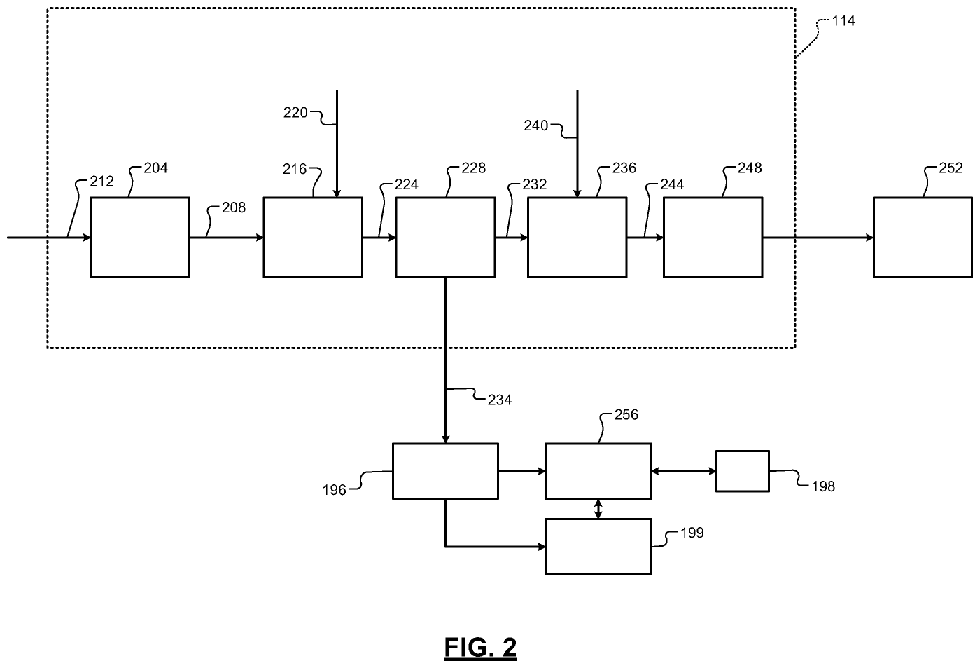

Referring now to FIG. 2, a functional block diagram of an example propulsion control system is presented. A driver torque module 204 determines a driver torque request 208 based on driver input 212. The driver input 212 may include, for example, an accelerator pedal position (APP), a brake pedal position (BPP), cruise control input, and/or an autonomous input. In various implementations, the cruise control input may be provided by an adaptive cruise control system that attempts to maintain at least a predetermined distance between the vehicle and objects in a path of the vehicle. The autonomous input may be provided by an autonomous driving system that controls movement of a vehicle from location to location while avoiding objects and other vehicles. The driver torque module 204 determines the driver torque request 208 based on one or more lookup tables that relate the driver inputs to driver torque requests. The APP and BPP may be measured using one or more APP sensors and BPP sensors, respectively.

The driver torque request 208 may be an axle torque request. Axle torques (including axle torque requests) refer to torque at the wheels. As discussed further below, propulsion torques (including propulsion torque requests) are different than axle torques in that propulsion torques may refer to torque at a transmission input shaft.

An axle torque arbitration module 216 arbitrates between the driver torque request 208 and other axle torque requests 220. Axle torque (torque at the wheels) may be produced by various sources including the engine 102 and/or one or more electric motors, such as the electric motor 198. Examples of the other axle torque requests 220 include, but are not limited to, a torque reduction requested by a traction control system when positive wheel slip is detected, a torque increase request to counteract negative wheel slip, brake management requests to reduce axle torque to ensure that the axle torque does not exceed the ability of the brakes to hold the vehicle when the vehicle is stopped, and vehicle over-speed torque requests to reduce the axle torque to prevent the vehicle from exceeding a predetermined speed. The axle torque arbitration module 216 outputs one or more axle torque requests 224 based on the results of arbitrating between the received axle torque requests 208 and 220.

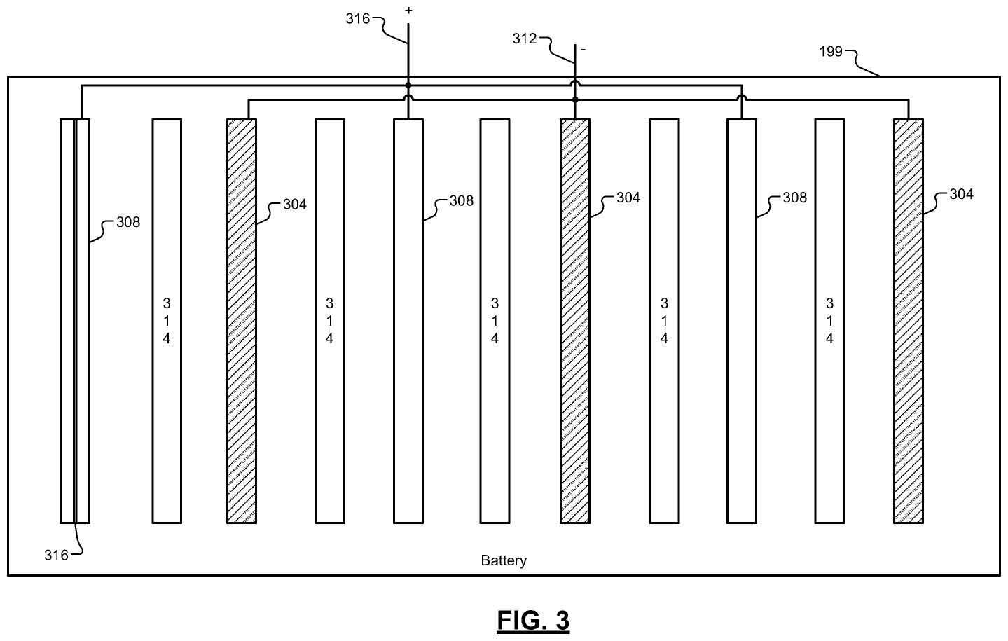

In hybrid vehicles, a hybrid module 228 may determine how much of the one or more axle torque requests 224 should be produced by the engine 102 and how much of the one or more axle torque requests 224 should be produced by the electric motor 198. The example of the electric motor 198 will be continued for simplicity in conjunction with the example of FIG. 2, but multiple electric motors may be included, such as discussed below with respect to the example of FIG. 3. The hybrid module 228 outputs one or more engine torque requests 232 to a propulsion torque arbitration module 236. The engine torque requests 232 indicate a requested torque output of the engine 102.

The hybrid module 228 also outputs a motor torque request 234 to the motor control module 196. The motor torque request 234 indicates a requested torque output (positive or negative) of the electric motor 198. In vehicles where the engine 102 is omitted (e.g., electric vehicles) or is not connected to output propulsion torque for the vehicle, the axle torque arbitration module 216 may output one axle torque request and the motor torque request 234 may be equal to that axle torque request. In the example of an electric vehicle, the ECM 114 may be omitted, and the driver torque module 204 and the axle torque arbitration module 216 may be implemented within the motor control module 196.

In electric vehicles, the driver torque module 204 may input the driver torque request 208 to the motor control module 196 and the components related to controlling engine actuators may be omitted. In the example of multiple electric motors, the motor control module 196 may determine how much torque should be produced by each of the electric motors. The electric motors may be controlled to achieve the same or different amounts of torque.

The propulsion torque arbitration module 236 converts the engine torque requests 232 from an axle torque domain (torque at the wheels) into a propulsion torque domain (e.g., torque at an input shaft of the transmission). The propulsion torque arbitration module 236 arbitrates the converted torque requests with other propulsion torque requests 240. Examples of the other propulsion torque requests 240 include, but are not limited to, torque reductions requested for engine over-speed protection and torque increases requested for stall prevention. The propulsion torque arbitration module 236 may output one or more propulsion torque requests 244 as a result of the arbitration.

An actuator control module 248 controls actuators 252 of the engine 102 based on the propulsion torque requests 244. For example, based on the propulsion torque requests 244, the actuator control module 248 may control opening of a throttle valve, timing of spark provided by spark plugs, timing and amount of fuel injected by fuel injectors, cylinder actuation/deactivation, intake and exhaust valve phasing, output of one or more boost devices (e.g., turbochargers, superchargers, etc.), opening of an EGR valve, and/or one or more other engine actuators. In various implementations, the propulsion torque requests 244 may be adjusted or modified before use by the actuator control module 248, such as to create a torque reserve.

The motor control module 196 controls switching of switches of an inverter module 256 based on the motor torque request 234. Switching of the inverter module 256 controls power flow from the battery 199 to the electric motor 198. As such, switching of the inverter module 256 controls torque of the electric motor 198. The inverter module 256 also converts power generated by the electric motor 198 and outputs power to the battery 199, for example, to charge the battery 199.

The inverter module 256 includes a plurality of switches. The motor control module 196 switches the switches to convert DC power from the battery 199 into alternating current (AC) power and to apply the AC power to the electric motor 198 to drive the electric motor 198. For example, the inverter module 256 may convert the DC power from the battery 199 into n-phase AC power and apply the n-phase AC power to (e.g., a, b, and c, or u, v, and w) n stator windings of the electric motor 198. In various implementations, n is equal to 3. Magnetic flux produced via current flow through the stator windings drives a rotor of the electric motor 198. The rotor is connected to and drives rotation of an output shaft of the electric motor 198.

In various implementations, one or more filters may be electrically connected between the inverter module 256 and the battery 199. The one or more filters may be implemented, for example, to filter power flow to and from the battery 199. As an example, a filter including one or more capacitors and resistors may be electrically connected in parallel with the inverter module 256 and the battery 199.

While the battery 199 is discussed in conjunction with the vehicle, the present application is also applicable to uses of the battery 199 in other types of devices including non-vehicle applications.

FIG. 3 is a functional block diagram of an example implementation of the battery 199. The battery 199 includes a plurality of electrodes. The electrodes include anodes 304 and cathodes 308. While the example of the battery 199 including three sets of cathodes and anodes, the battery 199 may have one or more sets of cathodes and anodes. The anodes 304 are electrically connected to a negative bus and terminal 312 of the battery 199. The cathodes 308 are electrically connected to a positive bus bar and terminal 316 of the battery 199. The battery 199 can output and receive power (discharge and charge) via the positive and negative terminals. An electrolyte, such as lithium hexaflourophosphate (LiPF₆) is provided within the battery 199. While the example of lithium hexaflourophosphate is provided, the present application is also applicable to other types of electrolytes including lithium and other types of electrolytes, such as organic solvents, e.g., esters, F-carbonate, and ethers. The electrolyte includes a lithium salt, such as salts, e.g., LiPF₆, LiTSI, or LiBF₄.

The battery 199 may also include one or more other components. For example, separators 314 may be disposed between the anodes and the cathodes current collectors (e.g., 316) may be disposed within the electrodes, and one or more other components may be included.

The anodes and cathodes 304 and 308 may be made of one or more (e.g., metal) materials or one or more other types of materials that is/are electrically conductive. As an example, the anodes 304 may be made of and include lithiated graphite (LiC6), silicon (Si), silicon oxide (SiOx), lithium silicon oxide (LiSiOx), graphite and silicon, or one or more other suitable types of metal. The anodes 304 may be lithiated after the formation process. As examples, the cathodes 308 may be made of a lithium iron phosphate (LFP), lithium nickel manganese cobalt oxide (NCM), (a) Rock salt layered oxides, LiNixMnyCo1-x-yO2, LiNixMn1-xO2, Li1+xMO2 e.g. LiCoO2, LiNiO2, Li MnO2, LiNi0.5Mn0.5O2, NMC111, NMC523, NMC622, NMC721, NMC811, NCA, etc., a Spinel cathode, e.g. LiMn2O4, LiNi0.5Mn1.5O4, include Olivine compounds, e.g. LiV2(PO4)3 LiFePO4, LiCoPO4, LiMnPO4 etc., include Tavorite compounds, e.g. LiVPO4F, include Borate compounds, e.g. LiFeBO3, LiCoBO3, LiMnBO3, include Silicate compounds, e.g. Li2FeSiO4, Li2MnSiO4, LiMnSiO4F, include Organic compounds, e.g., Dilithium (2,5-dilithiooxy)terephthalate, polyimide, include silicon dioxide (SiO2), included coated and/or doped cathode materials mentioned in above, include a combination of the above, or include one or more other suitable type of materials. The anodes and the cathodes 304 and 308 may be interleaved and alternating such that an anode is disposed between two consecutive cathodes, and a cathode is disposed between two consecutive anodes, such as illustrated. The anodes and the cathodes are formed during a process that may be referred to as formation (or cell formation). The electrolyte is injected into the battery 199 through one or more apertures. Formation may be deemed completed (and the anodes and cathodes may be charged) when a predetermined number (e.g., 1 or more) cycles of charging and discharging of the battery 199 have been performed with the electrolyte within the battery 199.

During charging and discharging of the battery, dendrite may form or be deposited on/around the electrodes. Dendrite on an anode may cause small short circuits between the anode and the cathode.

The present application involves applying a polytetrafluoroethylene (PTFE) to one of the electrodes, such as all of the anodes 304 prior to the formation process being performed and before the electrolyte is input to the battery 199. During the formation process, within the battery 199 (in-situ), the PTFE completely or partially reacts with the lithium metal of the electrodes and to create a lithium fluoride (LiF) layer disposed on the electrodes. The LiF layer provides a smooth protective layer that decreases inhomogeneous lithium deposition (e.g., around tips/protrusions of the electrodes) and suppresses dendrite growth and deposition during later use and cycling of the battery 199. If part of the PTFE layer remains, the (porous) PTFE layer reacts with dendrite during cycling to eliminate potential safety events. The following chemical equation may be representative of the LiF layer creation.

—(—CF₂)ₙ₋+2nLi⇒nC(amprphous)+2nLiF

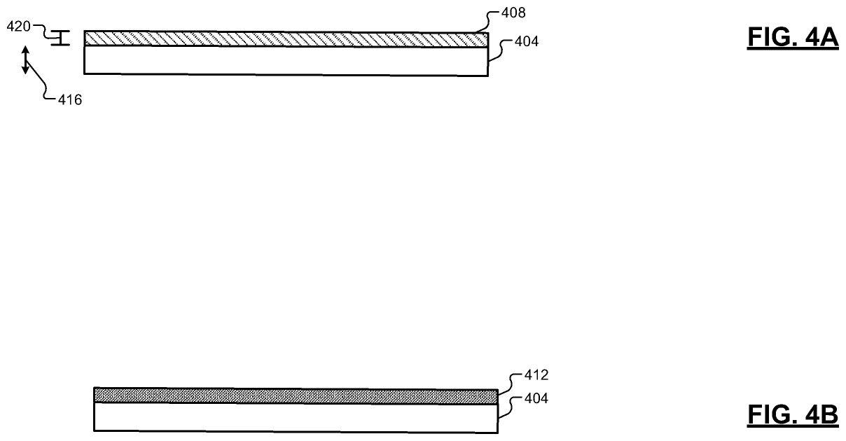

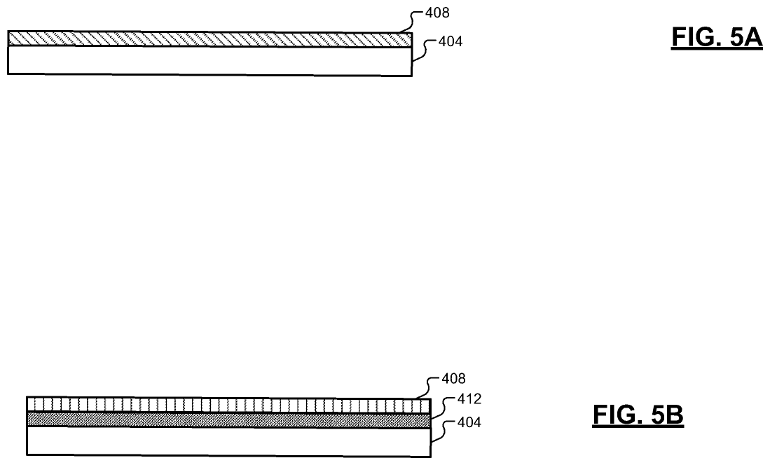

FIG. 4A includes a cross-sectional view of an example implementation of an electrode (e.g., an anode 404) before the formation process. FIG. 4B includes a cross-sectional view of an example implementation of the electrode (e.g., the anode 404) after the formation process. FIG. 5A includes a cross-sectional view of an example implementation of an electrode (e.g., an anode 404) before the formation process. FIG. 5B includes a cross-sectional view of an example implementation of the electrode (e.g., the anode 404) after the formation process.

As shown in FIGS. 4A and 5A, a PTFE layer 408 is disposed on a side (face) of the electrode 404. As shown in FIG. 4B, the performance of the formation process may cause the PTFE layer 408 to chemically convert (completely) into a LiF layer 412. As illustrated by FIG. 5B, in various implementations, the PTFE layer 408 may partially convert into the LiF layer 412 and a portion of the PTFE 408 may remain. In the example of FIG. 5B, the LiF 412 is disposed between the PTFE layer 408 and the electrode 404.

The lithium metal electrodes may be, for example, a lithium metal or lithium alloy, such as Lithium-lanthanide (Li—In), lithium-aluminum (Li—Al), or lithium magnesium (Li—Mg). The lithium metal electrodes (e.g., each side) may have a thickness (illustrated by 416 in FIG. 4A) of approximately 1 micrometers (μm) to approximately 50 μm or another suitable thickness. The PTFE layer may have a thickness (illustrated by 420 in FIG. 4A) of approximately 1 μm to approximately 25 μm or another suitable thickness. The PTFE may have a porosity of approximately 30-90% or another suitable porosity. The PTFE layer may be applied to the electrodes by pressing, rolling, or in another suitable manner. A temperature during application of the PTFE layer to the electrodes may be greater than a predetermined temperature, such as greater than 50 degrees Celsius or another suitable temperature. The PTFE layer may be applied to the electrodes in the form of a PTFE film, by coating the PTFE onto the electrodes, by spraying the PTFE onto the electrodes, or in another suitable manner. Approximately may mean+/−10 percent.

The cathode electrodes may include, for example LFP, carbon, and a binder material. Mass percentages may be 80-99% LFP, 0.5-20% carbon, and 0.5-10% binder or other suitable mass percentages. Loading of the cathode electrodes may be, for example, 0.5 milliamp hour (mAh) per centimeter squared (cm 2) to approximately 20 mAh/cm 2 or other suitable loading. The cathode electrodes may include a conductive filler material, such as carbon black, graphite, graphene, graphene oxide, Super P, acetylene black, carbon nanofibers, carbon nanotubes, or other suitable types of electrically conductive additives/fillers. The binder may be, for example, PTFE, sodium carboxymethylcellulose (CMC), styrene-butadiene rubber (SBR), polyvinylidene fluoride (PVDF), nitrile butadiene rubber (NBR), styrene ethylene butylene styrene copolymer (SEBS), styrene butadiene styrene copolymer (SBS) or another suitable binder. Examples of cathode materials include rock salt layered oxides and other suitable cathode materials.

The separators may have a thickness of approximately 1 μm to approximately 50 μm or another suitable thickness. The separators may include polyolefins (e.g., polypropylene (PP), polyethylene (PE)) with or without a ceramic coating. The ceramic may be, for example, Al₂O₃, ZrO₂, or another suitable ceramic. The current collectors may be made of a solid metal foil, a meshed foil, a three dimensional (3D) metal foam, or another suitable material. The current collectors may have a thickness of approximately 4 μm to approximately 20 μm or another suitable thickness.

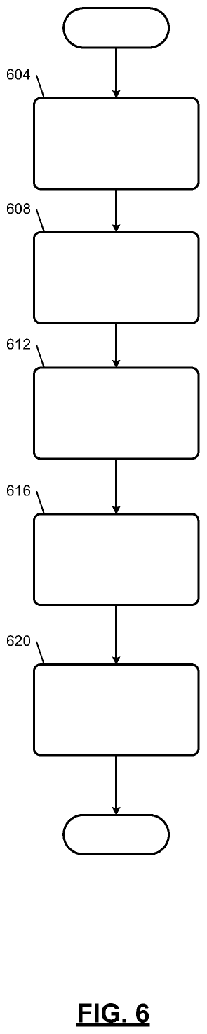

FIG. 6 is a flowchart depicting an example method of manufacturing a battery including disposing a LiF layer on the electrodes of the battery. The method begins with 604 where the PTFE is applied to the electrodes. At 608, the electrodes (with the applied PTFE) are disposed and electrically connected within the battery (housing).

At 612, the electrolyte is added (e.g., filled) into the battery, such as one or more apertures in the housing. At 616, once the battery is full of the electrolyte, the battery is sealed, such as by plugging the one or more apertures. At 620, the formation process is performed by performing the predetermined number of cycles (e.g., 1 cycle) of charging and discharging the battery to predetermined states of charge (SOCs).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery, comprising:
an anode electrode including a lithium metal;
a cathode electrode; and
a lithium fluoride (LiF) layer disposed on at least one of the anode electrode and the cathode electrode formed via a reaction between a polytetrafluoroethylene (PTFE) layer and the at least one of anode electrode and the cathode electrode during a formation process of the battery.

2. The battery of claim 1 further comprising a portion of the PTFE layer that remains after the reaction.

3. The battery of claim 2 wherein the LiF layer is disposed between the PTFE layer and the at least one of the anode electrode and the cathode electrode.

4. The battery of claim 2 wherein the PTFE layer has a porosity between approximately 30 percent and approximately 90 percent.

5. The battery of claim 1 wherein the LiF layer is disposed on the anode electrode.

6. The battery of claim 1 wherein the anode electrode includes lithiated metal.

7. The battery of claim 1 wherein the cathode electrode includes lithium iron phosphate (LFP).

8. The battery of claim 1 wherein the cathode electrode includes lithium nickel manganese cobalt oxide (NCM).

9. The battery of claim 1 further comprising an electrolyte that fills the battery.

10. The battery of claim 9 wherein the electrolyte includes a carbonate.

11. The battery of claim 9 wherein the electrolyte includes a lithium salt.

12. The battery of claim 1 further comprising a separator disposed between the anode electrode and the cathode electrode.

13. The battery of claim 1 wherein:
the lithium metal of the anode electrode is one of pure lithium and a lithium alloy; and
the lithium metal of the cathode electrode is one of pure lithium and a lithium alloy.

14. The battery of claim 1 wherein a thickness of the PTFE layer is between approximately 1 micrometer and approximately 25 micrometers.

15. The battery of claim 1 wherein a thickness of one side of the at least one of the anode electrode and the cathode electrode is between approximately 1 micrometer and approximately 50 micrometers.

16. A method of manufacturing a battery, comprising:
before performing a formation process of the battery, applying a polytetrafluoroethylene (PTFE) layer and to at least one of an anode electrode and a cathode electrode of the battery, the anode electrode including a lithium metal;
disposing the anode electrode and the cathode electrode within the battery;
filling the battery with an electrolyte; and
performing the formation process of the battery, the PTFE layer reacting with the at least one of the anode electrode and the cathode electrode and forming a lithium fluoride (LiF) layer on the at least one of the anode electrode and the cathode electrode.

17. The method of claim 16 wherein the applying the PTFE layer includes applying the PTFE layer to one of the anode electrode and the cathode electrode when a temperature of the at least one of the anode electrode and the cathode electrode is greater than a predetermined temperature.

18. The method of claim 16 wherein the applying the PTFE layer includes applying the PTFE layer by one of rolling, pressing, and spraying.

19. The method of claim 16 wherein the electrolyte includes a carbonate.

20. The method of claim 16 wherein the electrolyte includes a lithium salt.
